(19) United States
(12) Patent Application Publication
(10) Pub. No.: US 2023/0373339 A1
(43) Pub. Date: Nov. 23, 2023

(54) LOCATION BASED CONVENIENCE CHARGING

(71) Applicant: RIVIAN IP HOLDINGS, LLC, Irvine, CA (US)

(72) Inventor: Martin Hermez, West Bloomfield, MI (US)

(21) Appl. No.: 17/748,452

(22) Filed: May 19, 2022

(51) Int. Cl. B60L 53/66; H02J 7/00; B60L 58/12; G06Q 10/10; G06Q 30/02; G06Q 50/06

(52) U.S. Cl. CPC B60L 53/665; H02J 7/007; H02J 7/0048; B60L 58/12; G06Q 10/1097; G06Q 30/0283; G06Q 50/06

(57) ABSTRACT

Systems and methods are provided for convenience charging of an electric vehicle. A convenience charging system and related method, including, memory to store a charging schedule for charging an electric vehicle during a charging timeframe, processing circuitry to determine whether the current state of charge of the electric vehicle is insufficient to reach a priority location and in response to the electric vehicle being connected to a charger at a time outside of the charging timeframe of the charging schedule and determining that the current state of charge of the electric vehicle is insufficient to reach the priority location, facilitate initiation of charging at an earlier time than the charging timeframe so that the electric vehicle is charged to a sufficient range to reach the priority location.

### INTRODUCTION

The present disclosure is directed to convenience charging systems and methods for electric vehicles, and more specifically to charging an electric vehicle, outside of a charging schedule, to have sufficient range to reach one or more priority locations.

### SUMMARY

In accordance with the present disclosure, systems and methods are provided to improve the charging capabilities of an electric vehicle, such that it is able to reach priority locations, for example, when coupled to a charging station. In some situations, electric vehicles are charged according to a schedule. For example, a user may connect an electric vehicle to a home charging station whenever the user parks at home. However, the vehicle will not begin charging until the current time reaches the scheduled charging time. For example, the scheduled charging time may be at night when the cost of charging is cheaper. Therefore, if a user were to connect a vehicle, which is low on charge, to a home charger during the middle of the day, the vehicle will have a low range for the rest of the day until the scheduled charging time is reached. This may prevent the user from reaching a destination in the afternoon without charging the vehicle first.

According to the present disclosure, convenience charging is provided that enables an electric vehicle to be charged, outside of its charging schedule, so that it can reach one or more priority locations. The priority locations can be either user-inputted or determined by the convenience charging system (e.g., a closest hospital). In some embodiments, the convenience charging system determines the estimated cost to charge the vehicle out-of-schedule. The user may also set a cost sensitivity index, which is used to notify the user if the convenience charge will incur a cost greater than the sensitivity index. In some embodiments, if the estimated cost to convenience charge the vehicle is less than the sensitivity index, the user may not be notified and the vehicle will be convenience charged out-of-schedule. When the estimated cost to convenience charge is greater than the sensitivity index, the user may be notified with options to cancel or continue with the convenience charge.

In accordance with the present disclosure, systems and methods are provided for convenience charging of an electric vehicle and may include memory configured to store a charging schedule for charging the electric vehicle during a charging timeframe, and processing circuitry that is configured to determine whether an electric vehicle (e.g., a current state of charge of the electric vehicle) has insufficient charge to reach a priority location. The processing circuitry is further configured to, when the vehicle is connected to a charger outside of the charging schedule (e.g., outside of the charging timeframe) with insufficient charge to reach the priority location, facilitate the initiation of charging at an earlier time than the charging schedule so that the vehicle is charged to a sufficient range to reach the priority location. In some embodiments, the charging schedule comprises a user-inputted charging timeframe for when to charge the electric vehicle.

In some embodiments of the present disclosure, the processing circuitry may be further configured to determine the priority location based on user driving history. In some embodiments, the processing circuitry may be further configured to determine the priority location by searching for one or more emergency locations closest to the electric vehicle (e.g., based on the preference of the user). These emergency locations may include one or more of a hospital, medical clinic, veterinarian office, or a user-inputted location.

In some embodiments, the processing circuitry may be further configured to determine the route distance to each of the plurality of emergency locations, determine the longest route distance of the determined route distances, and determine whether the electric vehicle has insufficient charge to reach the priority location with the longest route distance. In some embodiments, the estimated cost to charge the electric vehicle to reach the sufficient range is determined by identifying the charge cost rate based on a current time of the day and the charger, determining the current electric vehicle range, determining the charge amount needed to reach the sufficient range based on a route distance to the priority location and the current electric vehicle range, and, lastly, determine the estimated cost to charge the electric vehicle based on the charge cost rate and the charge amount. In some embodiments, the processing circuitry may be configured to determine an estimated cost to charge the electric vehicle to reach the sufficient range based on a charge cost rate associated with the charge.

The convenience charging, in some embodiments, allows for the user to input a cost sensitivity index, which the processing circuitry compares to the estimated cost to charge the vehicle to reach the sufficient range. In response to the estimated cost exceeding the cost sensitivity index, the systems and methods provided within the present disclosure may notify the user, enabling the user to cancel or accept the convenience charging. In some embodiments of the present disclosure, the notification generated and sent to the user comprises a distance the electric vehicle can travel at the sufficient range or an identification of the priority location, the estimated cost to convenience charges the vehicle, and the option that enables the user to cancel the convenience charging.

In some embodiments, a non-transitory computer-readable medium is provided having non-transitory computer-readable instructions encoded thereon that, when executed by processing circuitry, cause the processing circuitry to determine whether an electric vehicle is connected to a charger at a time outside of a charging timeframe of a charging schedule and determine whether an electric vehicle has insufficient charge to reach a priority location. In response to determining that the electric vehicle is connected to a charger at a time outside of the charging schedule (e.g., outside of the charging timeframe) and determining that the electric vehicle does not have sufficient charge to reach the priority location, the non-transitory computer-readable instructions further cause the processing circuitry to facilitate the initiation of charging at an earlier time than the charging schedule so that the electric vehicle is charged to a sufficient range to reach the priority location.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a block diagram of components of a system for providing location based convenience charging of an electric vehicle, in accordance with some embodiments of the present disclosure;

FIG. 2 shows an illustrative depiction of a charging schedule, in accordance with some embodiments of the present disclosure;

FIG. 3A shows an illustrative graphical user interface providing information of priority locations including options to remove or add other priority locations, in accordance with some embodiments of the present disclosure;

FIG. 3B shows an illustrative graphical user interface for adding a priority location, in accordance with some embodiments of the present disclosure;

FIG. 4 shows an illustrative map with an electric vehicle connected to a charger and a plurality of priority locations, in accordance with some embodiments of this disclosure.

FIG. 5 shows a mobile phone graphical user interface including a notification indicating that the convenience charge exceeds the user-set cost sensitivity index, in accordance with some embodiments of the present disclosure;

FIG. 6 shows a flowchart of an illustrative process for determining whether a vehicle should be charged out of schedule to have sufficient range to reach a priority location, in accordance with some embodiments of the present disclosure;

FIG. 7 shows a flowchart of an illustrative process for determining the sufficient charge required to reach the farthest priority location of a plurality of priority locations, in accordance with some embodiments of the present disclosure; and

FIG. 8 shows a flowchart of an illustrative process for determining the cost of convenience charging and notifying the user, in accordance with some embodiments of the present disclosure.

### DETAILED DESCRIPTION

The present disclosure is directed to convenience charging an electric vehicle, outside of a charging schedule, to ensure the vehicle has sufficient charge to reach one or more priority locations. When the vehicle is connected to a charger and the vehicle does not have sufficient vehicle range to reach the one or more priority locations, the charging schedule is overridden, and the electric vehicle is charged out-of-schedule (i.e., at an earlier time) to a sufficient range to reach the one or more priority locations. In some embodiments, a notification is generated for display indicating, for example, the sufficient vehicle range to reach the priority location and the estimated charge cost to reach the sufficient vehicle range.

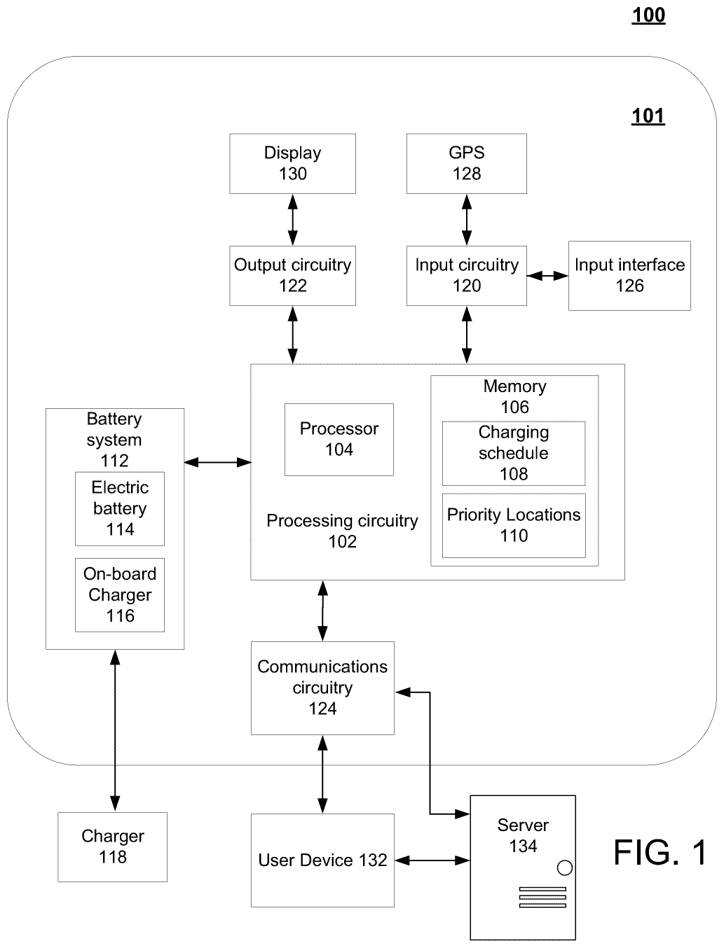

FIG. 1 shows a block diagram of components of a system 100 for providing location based convenience charging of an electric vehicle 101 in accordance with some embodiments of the present disclosure. In some implementations of the present disclosure, the electric vehicle 101 may be a car (e.g., a coupe, a sedan, a truck, an SUV, a bus), a motorcycle, an aircraft (e.g., a drone), a watercraft (e.g., a boat), or any other type of vehicle.

The electric vehicle 101 may comprise processing circuitry 102 which may comprise processor 104 and memory 106. Processor 104 may comprise a hardware processor, a software processor (e.g., a processor emulated using a virtual machine), or any combination thereof In some embodiments, processor 104 and memory 106 in combination may be referred to as processing circuitry 102 of vehicle 101. In some embodiments, processor 104 alone may be referred to as processing circuitry 102 of vehicle 101. Memory 106 may comprise hardware elements for non-transitory storage of commands or instructions, that, when executed by processor 104, cause processor 104 to operate vehicle 101 in accordance with embodiments described above and below. The memory 106 may further store a charging schedule 108 (e.g., user inputted), as well as a set of priority locations 110. The priority locations 110 may be based on user input, but in some embodiments of the present disclosure, may also be determined by the processing circuitry 102. Processing circuitry 102 may be communicatively connected to components of vehicle 101 via one or more wires, or via wireless connection.

Processing circuitry 102 may be communicatively connected to battery system 112, which may be configured to provide power to one or more of the components of vehicle 101 during operation. Battery system 112 may comprise electric battery 114, which may include one or more battery modules. In some embodiments, battery 114 may be a 180 kWh battery pack or a 135 kWh battery pack. Battery system 112 may further comprise on-board charger 116 to manage the flow of electricity to electric battery 114 (e.g., to perform AC-DC conversion when charger 118 is an AC charger), and any other suitable components. In some embodiments, on-board charger 116 may include connectors for interfacing with charger 118. Battery system 112 may be configured to manage charging of battery 114, which may include convenience charging, charging according to a charging schedule, measuring one or more characteristics of battery 114, identifying the charge to determine the range of distance that the vehicle 101 may travel, providing power to components of vehicle 101, communicating with charger 118, any other suitable actions, or any combination thereof. Battery system 112 may include, for example, electrical components (e.g., switches, bus bars, resistors, capacitors), control circuitry (e.g., for controlling suitable electrical components), and measurement equipment (e.g., to measure voltage, current, impedance, frequency, temperature, or another parameter). Battery system 112 may provide charge status information to processing circuitry 102. Charge status information includes, for example, charge level, whether the battery 114 is being charged, charging current, charging voltage, charging mode, and whether a charging fault exists.

In some embodiments, electric vehicle 101 may be plugged, or otherwise connected to, charger 118 via a cable (e.g., having a SAE J1772 charging plug, a CCS connector, etc.), having more than one conductor of suitable gauge. Such cable may include conductors for carrying charging current and conductors for transmitting information. It will be understood that any suitable arrangement of leads may be used in accordance with the present disclosure.

Charger 118 may be coupled to a power source, e.g., a power transmission grid, a solar panel, a generator, a wind turbine, or another vehicle, and may be configured to provide charging current at a suitable charging voltage to battery 114 of electric vehicle 101. In some embodiments, charger 118 may correspond to a charger at a DC station (e.g., DC fast electric charging station) or AC station. Charger 118 may be, for example, a fixed charging station (e.g., a charging station installed in a public location or in a user's home), or a portable charger (e.g., a charger connected to a portable generator, a portable solar panel, or another vehicle). In some embodiments, charger 118 may be capable of charging battery 114 at one or more voltages, with one or more current limitations. For example, charger 118 may receive information from battery system 112 indicating what voltage, current, or both, electric vehicle 101 may be charged with. Charger 118 may provide a charging current that is limited by one or more constraints. For example, electric vehicle 101 may communicate to charger 118 what charging current is desired for charging. In a further example, a cable type may have a maximum associated current capacity based on insulation and heat transfer considerations. In some embodiments, charger 118 and on-board charger 116 support the inflow of current from battery 114 via a coupling.

An input interface 126 (e.g., a steering wheel, a touch screen display, buttons, knobs, a microphone, or other audio capture device, etc.) may be commutatively coupled to the processing circuitry 102 via input circuitry 120. In some embodiments, a driver of vehicle 101 may be permitted to select certain settings in connection with the operation of vehicle 101 (e.g., input a charging schedule, input a priority location, etc.). In some embodiments, processing circuitry 102 may be communicatively connected to a navigation system, e.g., Global Positioning System (GPS) system 128 of vehicle 101, where the driver may interact with the GPS system 128 via input interface 126. GPS system 128 may be in communication with multiple satellites to ascertain the vehicle's location and provide route distance between the vehicle's location and a priority location to the processing circuitry 102. As another example, the positioning device may operate on terrestrial signals, such as cell phone signals, Wi-Fi signals, or ultra-wideband signals to determine a location of electric vehicle 101. The determined location may be in any suitable form such as a geographic coordinate, a street address, a nearby landmark such as an identification of the nearest charging station or a tagged location associated with the vehicle (e.g., a location of a home or priority location 110 of the user stored in memory 106). In some embodiments, processing circuitry 102 uses the determined location to identify whether the vehicle is within a range of a priority location (e.g., is within a range to a hospital, grandmother's house, etc.). In some embodiments, battery system 112 may utilize the determined location to identify whether charger 118 is a home charging station or a non-home charging station (e.g., a public charging station, etc.).

Processing circuitry 102 may be communicatively connected to display 130 by way of output circuitry 122. Display 130 may be located at a dashboard of vehicle 101 and/or a heads-up display at a windshield of vehicle 101. Additionally or alternatively, the display 130 may be a screen associated with charger 118. For example, display 130 may comprise an LCD display, an OLED display, an LED display, or any other type of display. In some embodiments, display 130 may provide a driver with information regarding the sufficient charge range to reach priority locations and estimated charge cost information based on information output by battery system 112.

In some embodiments, processing circuitry 102 may be in communication (e.g., via communications circuitry 124) with user device 132 (e.g., a mobile device, a computer, a key fob, etc.). Such connection may be wired or wireless. The processing circuitry 102 may also be in communication (e.g., via communications circuitry 124) with user device 132 wirelessly through a server 134. In some embodiments, user device 132 may execute instructions stored in memory to perform convenience charging functionality. For example, user device 132 may receive and display the sufficient range to reach a priority location and the estimated charge cost, based on information output by battery system 112. The user may be prompted on user device 132 with a notification when the estimated charge cost exceeds a user-set cost sensitivity index. In some embodiments of the present disclosure, the notification may include options of whether to convenience charge even though the charge cost exceeds the cost sensitivity index. The user may accept or decline the convenience charge via a graphical user interface on the user device 132.

It should be appreciated that FIG. 1 only shows some of the components of vehicle 101, and it will be understood that vehicle 101 also includes other elements commonly found in vehicles (e.g., electric vehicles), e.g., a motor, brakes, wheels, wheel controls, turn signals, windows, doors, etc.

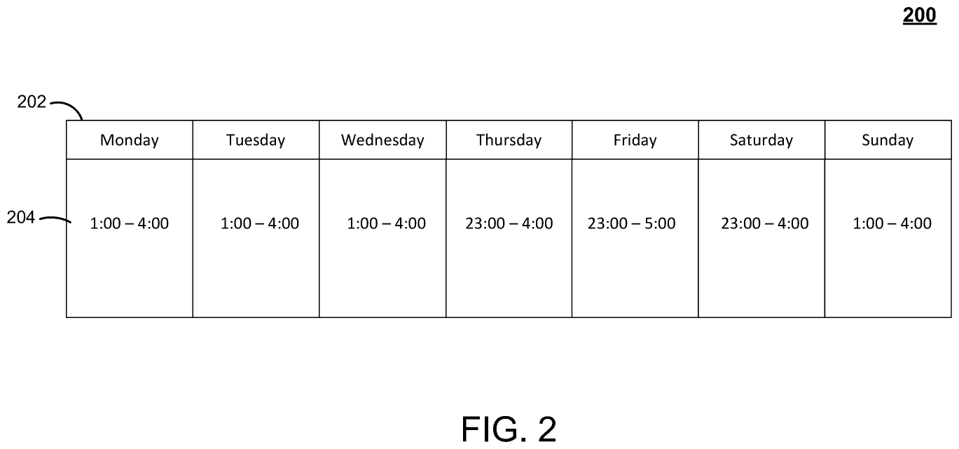

FIG. 2 shows an illustrative depiction of a charging schedule 200, in accordance with some embodiments of the present disclosure. In some embodiments, charging schedule 200 corresponds to charging schedule 108 stored in memory 106 of vehicle 101. In some embodiments, charging schedule 200 is additionally or alternatively stored on user device 132 or server 134. In some embodiments, the charging schedule 200 is comprised of a data structure that may include each day of a week 202 (e.g., Monday, Tuesday, etc.), which is paired with charging timeframe 204 that may be shown as a range of time during the given day 202. The charging timeframe 204 indicates when vehicle 101 will initiate charging when connected to the charger 118. Charging schedule 200 can be used to determine whether the vehicle 101 is connected to a charger within or outside of a charging schedule. In accordance with the present disclosure, convenience charging occurs outside of a charging schedule (e.g., outside of the charging timeframe). For example, on Monday of charging schedule 200, the charging timeframe 204 is 1:00-4:00. Therefore, the times 0:00-1:00 and 4:00-24:00 are when vehicle 101 is outside of the charging schedule and convenience charging may take place. In some embodiments, the charging schedule 200 may be created by a user (e.g., via input interface 126 of vehicle 101). However, the charging schedule may be automatically created by the processing circuitry 102, which may be able to determine the time of day for the vehicle to charge based on user preferred parameters, such as charging cost.

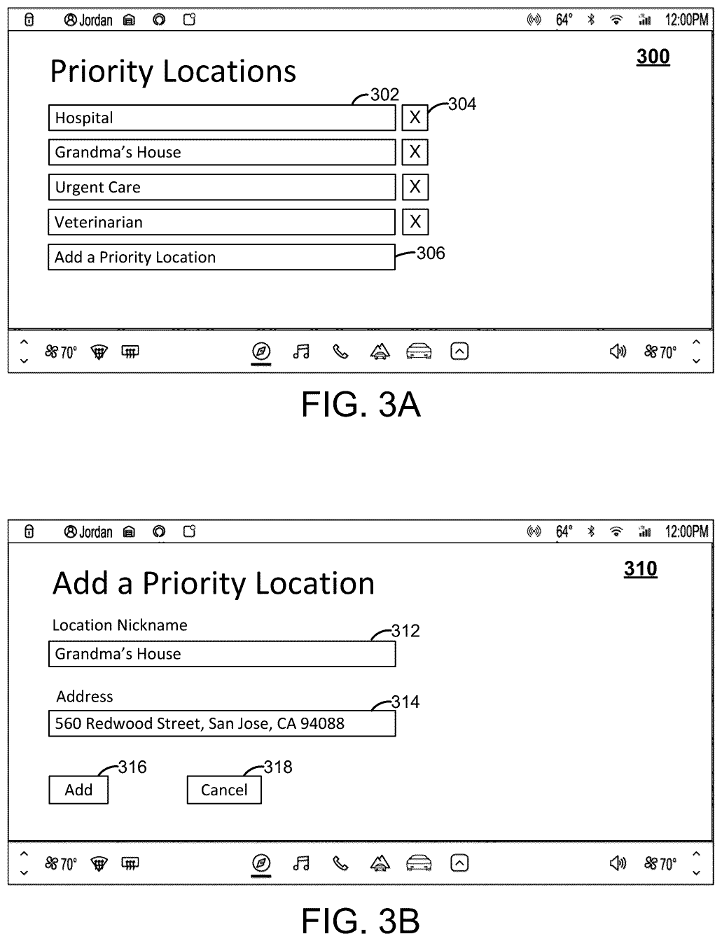

FIG. 3A shows an illustrative graphical user interface 300 providing information of priority locations 302, including options to remove 304 or add 306 other priority locations, in accordance with some embodiments of the present disclosure. In some embodiments, graphical user interface 300 may be displayed on display 130 (via output circuitry 122) or on user device 132 (via communications circuitry 124 or server 134). In some embodiments, the graphical user interface 300 shows the priority location 302 that are stored in memory 106. Each of the priority locations 302 may be used to determine the minimum sufficient range to reach the farthest priority location 302. In some embodiments of the present disclosure, the priority locations 302 are user-inputted by selecting the add a priority location option 306. The user may also remove a priority location 302 by removing a set priority location 304. Each priority location 302 is shown by a priority location nickname or priority location type that is associated with a geographical location (e.g., an address, GPS coordinates, etc.). FIG. 3A shows four occupied priority locations 302 slots with an option to add more priority locations 306. However, in some other embodiments of the present disclosure there may be more or less priority locations. When a user selects to remove a priority location 304, the priority location name 302 clears such that it becomes available as another option to add a priority location 306. When a user selects to add a priority location 306 the user is presented with the add a priority location graphical user interface shown in FIG. 3B.

FIG. 3B shows an illustrative graphical user interface 310 for adding a priority location, in accordance with some embodiments of the present disclosure. The graphical user interface 310 includes a priority location nickname entry slot 312 for the user to enter a display name for the priority location on the main priority locations graphical user interface 300. The user may also select a geographical location (e.g., an address, GPS coordinates, etc.) and enter it into the address entry slot 314 on the graphical user interface 310. This entered geographical location 314 is used when determining the priority location route distance from the vehicle location. When the user has entered the priority location nickname 312 and the geographical location 314, the user may select the add button 316 to add the information as a priority location. In some embodiments of the present disclosure there may also be a cancel option 318 to cancel this operation, which may return the user to the main priority location graphical user interface 300 without adding any new priority location data. In some embodiments of the present disclosure, the user may enter a priority location by entering a priority location type (e.g., hospital, urgent care, veterinarian, etc.). For example, a user may enter a priority location type in entry slot 312 instead of a nickname. When a priority location type is entered, the address entry slot 314 may be disabled because the address for the entered priority location type will depend on the location of the vehicle. For example, when “hospital” is entered as a priority location type, the closest “hospital” can be identified using, for example, GPS system 128.

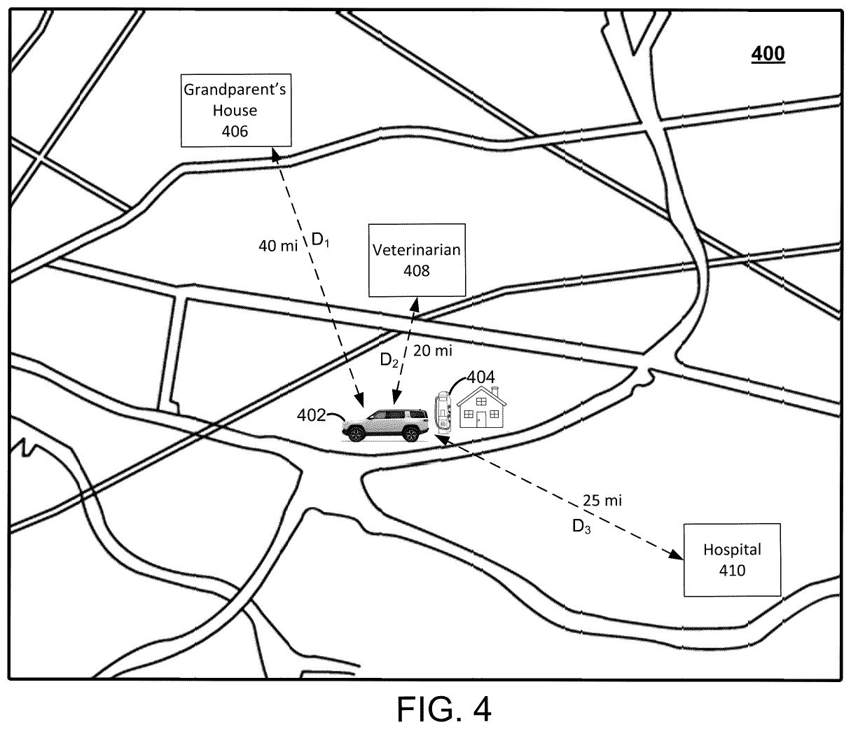

FIG. 4 shows an illustrative map 400 with an electric vehicle 402 connected to a charger 404 and a plurality of priority locations (e.g., 406, 408, 410), in accordance with some embodiments of this disclosure. Illustrative map 400 visually depicts a vehicle 402 and the geographic locations of the priority locations 406, 408, 410. In some embodiments, this map may be displayed to a user (e.g., as a part of a convenience charge notification) on a display 130 of the vehicle 101 or on a display of the user device 132. Vehicle 402 is shown coupled to a house charging station 404 and there are three surrounding priority locations (e.g., Grandparents' House 406, Veterinarian 408, and Hospital 410). In some embodiments, vehicle 402 may correspond to vehicle 101. In some embodiments, the convenience charging system determines the route distance between the vehicle 402 location and each of the priority locations 406, 408, 410. In some embodiments, the route distance refers to the distance along roadways and other parts of the transportation system (e.g., highways, tunnels, bridges, etc.), rather than direct point-to-point distance. As shown in FIG. 4, the route distance to each of the priority locations, Grandparents' House 406, Veterinarian 408, and Hospital 410, is determined as route distance D₁, route distance D₂, and route distance D₃, respectively. In the case of FIG. 4, Grandparents' House 406 is the farthest priority location with route distance D₁ of 40 miles. This farthest route distance is used to determine the minimum sufficient charge for the convenience charging system to charge the vehicle 402 to so that it can reach all of the priority locations. When the user couples the vehicle 402 to the charging station 404 outside of its schedule and the current range of the vehicle is less than the route distance D₁, the convenience charging system may determine to convenience charge the vehicle 402 outside of its charging schedule.

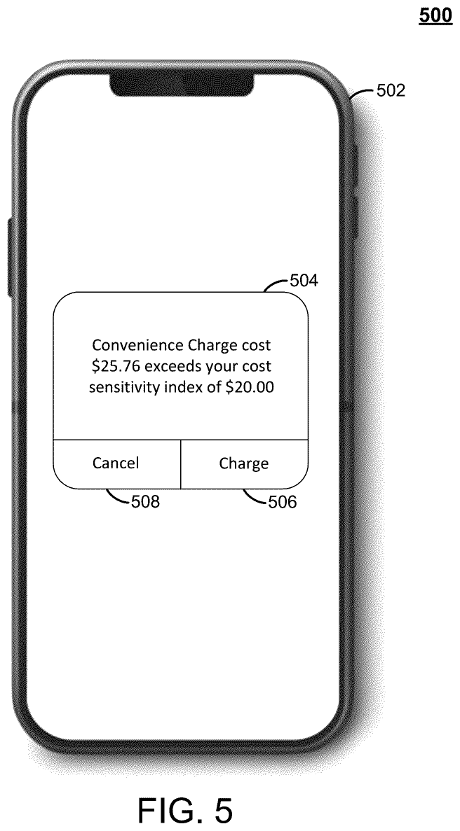

In some embodiments, when the vehicle 402 is coupled to charger 404, the priority locations may be identified based on the vehicle location. For example, vehicle 402 may 30 identify the closest priority location for each of the inputted emergency location types. If a user inputs a priority location type of a veterinarian's office, processing circuitry will search for the closest veterinarian office 408 to the vehicle 402. In some embodiments, the system may exclude priority locations that are greater than a predetermined maximum route distance from the current location of vehicle 402. The maximum distance may be user inputted or predetermined. For example, with a maximum route distance of 50 miles, if the farthest priority location has a route distance greater than the maximum distance, it may be excluded as a priority location and not used in determining whether to convenience charge vehicle 402. When the processing circuitry determines to convenience charge outside of the charging schedule, the processing circuitry may notify the user of the estimated cost to convenience charge the vehicle 402 by sending a notification, an example of which is seen in FIG. 5.

FIG. 5 shows a mobile phone graphical user interface 502 including a notification 504 indicating that the convenience charge exceeds the user-set cost sensitivity index, in accordance with some embodiments of the present disclosure. In some embodiments, the graphical user interface 502 may be presented on the user device 132 in FIG. 1. The notification 504 includes two options for the user to select, one to accept the convenience charge 506, and one to cancel the convenience charge 508. In some embodiments of the present disclosure, the notification may present information to the user including the estimated cost to charge the electric vehicle to reach the sufficient range based on the charge cost rate and the charge amount, as well as the user-inputted cost sensitivity index. When the user selects to accept the convenience charge 506 via graphical user interface 502, the vehicle will be convenience charged outside of its charging schedule. When the user selects to cancel the convenience charge 508, the vehicle will not be convenience charged and will instead be charged based on its charging schedule. Although FIG. 5 shows a graphical user interface 502 on a mobile phone, the notification 504 may be sent to any other user device (e.g., a computer, a key fob, etc.).

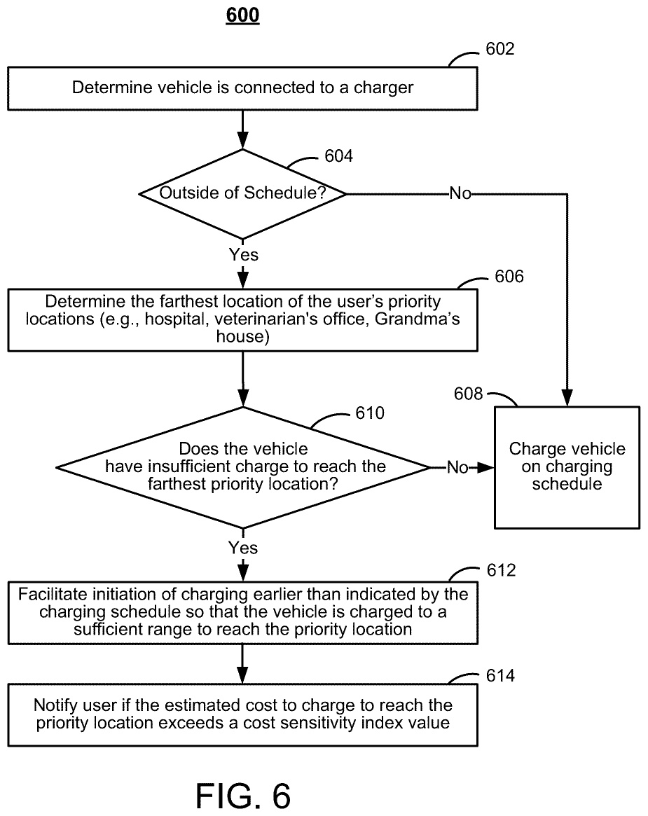

FIG. 6 shows a flowchart of an illustrative process 600 for determining whether a vehicle should be charged outside of a charging schedule to have sufficient range to reach a priority location, in accordance with some embodiments of the present disclosure. In some embodiments, process 600 is executed by processing circuitry 102 of electric vehicle 101. In some embodiments, the execution of process 600 is distributed across multiple devices (e.g., vehicle 101, charger 118, user device 132, and/or server 134).

At 602, processing circuitry 102 determines that vehicle 101 is connected to a charger such as charger 118. In some embodiments, charger 118 may send an interrupt signal or other signal to processing circuitry 102 such that the processing circuitry may determine when vehicle 101 is connected to the charger 118.

At 604, the processing circuitry 102 determines whether the vehicle 101 is connected to the charger 118 outside of the charging schedule. In some embodiments, the charging schedule may correspond to the charging schedule 200 stored in memory 106. In some embodiments, the processing circuitry 102 may retrieve the current date and time and the charging schedule 200 from memory 106 in order to determine whether the current time is outside of the charging schedule 200 (e.g., outside of timeframe 204 of charging schedule 200). In response to determining that it is not outside of the charging schedule 200, processing proceeds to 608, where the vehicle 101 is charged according to the charging schedule 200. Charging schedule 200 may indicate the timeframe when vehicle 101 charges and how much to charge vehicle 101.

At 606, in response to determining that it is outside of the charging schedule 200, the processing circuitry 102 determines the farthest location of the user's priority locations. In some embodiments, the priority locations may correspond to the priority locations 110 stored in memory 106. In some embodiments, the priority locations 110 may be retrieved from memory 106 or searched for based on user preferences and used by the processing circuitry 102 for determining route locations and distances. The illustrative map 400, which contains priority locations 406, 408, 410, illustrates three priority locations and corresponding route distances.

At 610, once the farthest priority location is determined, the processing circuitry 102 determines whether the vehicle 101 has insufficient charge to reach the farthest priority location. In some embodiments, processing circuitry 102 retrieves the current state of charge of the vehicle 101 from battery system 112, determines the vehicle range based on the current state of charge, and compares the vehicle range to the route distance of the farthest priority location to determine whether the vehicle 101 has insufficient charge. In some embodiments, the comparison includes ensuring that the vehicle can reach the farthest priority location with a minimum range remaining (e.g., at least 5, 10, 15, 20, etc. miles of range). In some embodiments, the processing circuitry 102 may determine the current vehicle range by retrieving this information from battery system 112. If the current vehicle range is insufficient to reach the farthest priority location, processing proceeds to 612 for convenience charging. Otherwise, processing proceeds to 608 as described above, where charging may not be initiated until indicated by the charging schedule.

At 612, the processing circuitry 102 facilitates initiation of charging earlier than indicated by the charging schedule (e.g., at an earlier time than the charging timeframe of the charging schedule) so that the vehicle is charged to a sufficient range to reach the priority location. In some embodiments, the sufficient range is greater than or equal to the distance to the farthest priority location. For example, the sufficient range may be 0, 5, 10, 15, 20, 25, etc. miles greater than the distance to the farthest priority location. In some embodiments, the processing circuitry 102 facilitates initiation of charging by sending a signal to battery system 112 and/or charger 118 to begin charging vehicle 101.

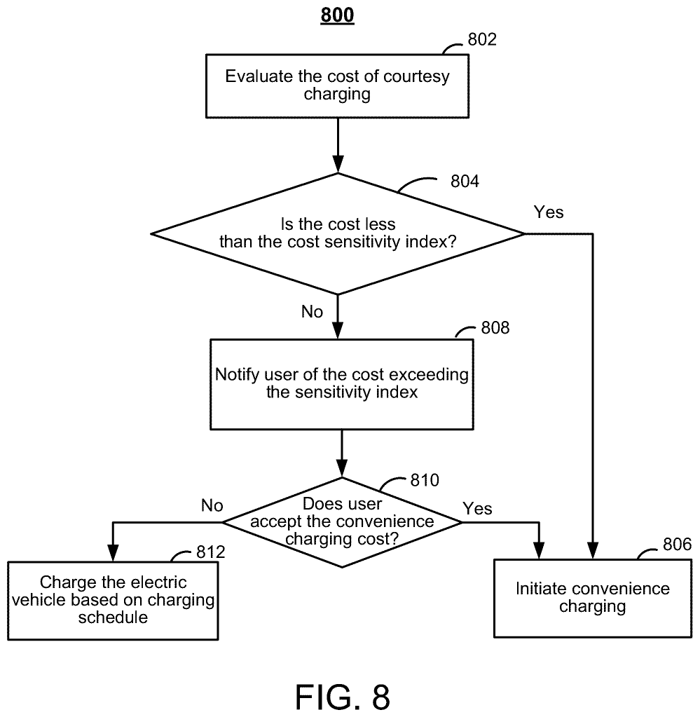

At 614, the processing circuitry 102 may notified the user if the estimated cost to charge to reach the priority location exceeds a cost sensitivity index value. In some embodiments the user notification may correspond to notification 504 and may be generated for display on a user device (e.g., a mobile device, a computer, a key fob, etc.). The notification may be informative or the notification may prompt the user to proceed or cancel the convenience charging. Further details about notifications are explained in connection with FIG. 8.

It will be understood that process 600 of FIG. 6 is merely illustrative and that various modifications can be implemented in accordance with the present disclosure. For example, in some embodiments, step 614 may be omitted. As another example, the priority locations of step 606 may exclude priority locations that are more than a predetermined maximum route distance (e.g., 50, 75, 100, etc. miles) away from vehicle 101.

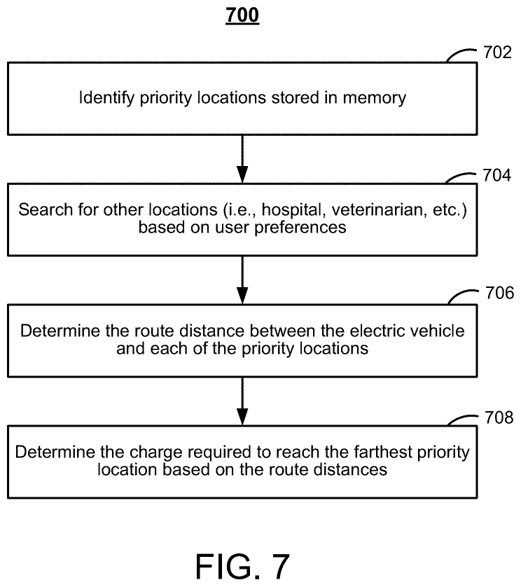

FIG. 7 shows a flowchart of an illustrative process 700 for determining the sufficient charge required to reach the farthest priority location of a plurality of priority locations, in accordance with some embodiments of the present disclosure. In some embodiments, process 700 is executed by processing circuitry 102 of electric vehicle 101. In some embodiments, the execution of process 700 is distributed across multiple devices (e.g., vehicle 101, charger 118, user device 132, and/or server 134). In some embodiments, process 700 is implemented as part of steps 606, 610, and 612 of process 600.

At 702, processing circuitry 102 identifies priority locations stored in memory 106. These priority locations may, for example, be user inputted priority locations (e.g., Grandma's House) that have specific addresses.

At 704, processing circuitry 102 searches for other locations, for example, based on user preferences. In some embodiments, the searches are performed based on priority location types (e.g., hospital, urgent care center, veterinarian, etc.), which may be inputted by the user or selected based on user preferences. The search may be performed based on the location of vehicle 101. For example, the search may identify, for each priority location type, the result that is closest to the vehicle 101. This can be useful when the user has traveled far from their usual priority locations but may still want to access similar types of locations in case of an emergency. For example, if a user inputted a particular police station and hospital near the user's home address as priority locations, these inputs can be used as user preferences when the user is traveling away from home. This way, the processing circuitry 102 can search for a nearby police station and hospital when the user is away from home and when vehicle 101 connected to a charger 118.

At 706, once the priority locations are all identified at 702 and 704, the processing circuitry 102 determines the route distance between the current position of vehicle 101 and each of the priority locations. In some embodiments, the route distance refers to the distance along roadways and other parts of the transportation system (e.g., highways, tunnels, bridges, etc.), rather than direct point-to-point distance. In some embodiments, the processing circuitry 102 may use GPS system 128 to determine the route distance between the current vehicle position to each of the priority locations.

At 708, the processing circuitry 102 determines the charge required to reach the farthest priority location based on the determined route distances. In some embodiments, the processing circuitry 102 may compare the route distances of each of the priority locations and determine the priority location with the greatest route distance. In some embodiments, the processing circuitry 102 may exclude route distances that are greater than a predetermined maximum route distance. In some embodiments, the processing circuitry 102 determines the charge that correlates with a vehicle range to reach the farthest priority location and whether vehicle 101 has sufficient charge (e.g., state of charge) to reach the farthest priority location. The processes of evaluating the cost of convenience charging and notifying the user is shown in more detail in FIG. 8.

FIG. 8 shows a flowchart of an illustrative process 800 for determining the cost of convenience charging and notifying the user, in accordance with some embodiments of the present disclosure. In some embodiments, process 800 is executed by processing circuitry 102 of electric vehicle 101. In some embodiments, the execution of process 800 is distributed across multiple devices (e.g., vehicle 101, charger 118, user device 132, and/or server 134). In some embodiments, process 800 is implemented as part of steps 612 and 614 of process 600.

At 802, the processing circuitry 102 evaluates the cost of convenience charging. In some embodiments, the processing circuitry 102 compares the current state of charge with the charge needed to reach the priority location (e.g., as determined at 708). Based on the difference between the current state of charge and the charge needed to reach the priority location (i.e., the charge amount), the processing circuitry 102 can compute the cost of convenience charging based on the charge cost rate. For example, if the charge amount is 40 kWh and the charge cost rate is 15 cents/kWh, then the cost of the convenience charging is $6.00.

At 804, the processing circuitry 102 determines whether the cost of convenience charging is less than a cost sensitivity index. In some embodiments, the cost sensitivity index is a user-inputted value that indicates a cost above which the user would like a notification. In some embodiments, a default cost sensitivity index is used. In response to determining that the cost of convenience charging is less than the cost sensitivity index, processing proceeds to 806, where convenience charging is initiated and the vehicle is charged a sufficient amount, outside of the charging schedule, to reach the priority location. Otherwise, processing proceeds to 808.

At 808, the processing circuitry 102 notifies the user of the cost exceeding the sensitivity index. In some embodiments, the notification may correspond to notification 504 and may be generated for display on a user device 132 (e.g., a mobile device, a computer, a key fob, etc.). In some embodiments, the notification may be generated by the processing circuitry 102 and sent to the user device 132 (via the communications circuitry 124) wirelessly by way of local transmission (e.g., Bluetooth, RFID, etc.) or through the server 134. In some embodiments, the notification 504 prompts the user with options to proceed with (e.g., charge 506) or cancel (e.g., cancel 508) the convenience charging.

At 810, the processing circuitry 102 determines whether the user accepted the convenience charging cost. When the user accepts the convenience charging cost (e.g., selects charge 506), the process proceeds to 806 for convenience charging as described above. When the user does not accept the convenience charging cost (e.g., selects cancel 508), the process proceeds to 812, where the vehicle 101 is charged according to the charging schedule 200. In some embodiments, the user's decision is transmitted as a signal to the processing circuitry 102 (via the communications circuitry 124), which in turn can initiate convenience charging by sending a signal to battery system 112 or charger 118. In some embodiments, processing circuitry 102 can interpret a lack of a user response as either an acceptance or a cancellation of convenience charging (e.g., based on user preferences or a default system setting).

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A system, comprising:
memory configured to store a charging schedule for charging an electric vehicle during a charging timeframe; and
processing circuitry configured to:
determine whether a current state of charge of the electric vehicle is insufficient to reach a priority location; and
in response to (a) the electric vehicle being connected to a charger at a time outside of the charging timeframe of the charging schedule and (b) determining that the current state of charge of the electric vehicle is insufficient to reach the priority location, facilitate initiation of charging at an earlier time than the charging timeframe so that the electric vehicle is charged to a sufficient range to reach the priority location.

2. The system of claim 1, wherein the processing circuitry is further configured to determine the priority location based on user driving history.

3. The system of claim 1, wherein the processing circuitry is further configured to determine the priority location by searching for one or more emergency locations closest to the electric vehicle.

4. The system of claim 3, wherein the one or more emergency locations comprises one or more of a hospital, medical clinic, veterinarian office, or a user inputted priority location.

5. The system of claim 3, wherein:
the one or more emergency locations comprise a plurality of emergency locations;
the processing circuitry is further configured to:
determine a route distance to each of the plurality of emergency locations; and
determine a longest route distance of the determined route distances; and
the processing circuitry is configured determine whether the current state of charge of the electric vehicle is insufficient to reach the priority location based on the longest route distance.

6. The system of claim 1, wherein the processing circuitry is further configured to determine an estimated cost to charge the electric vehicle to reach the sufficient range based on a charge cost rate associated with the charge.

7. The system of claim 6, wherein the processing circuitry is configured to determine the estimated cost to charge the electric vehicle to reach the sufficient range by:
identifying the charge cost rate based on a current time of day and the charger;
determining a current electric vehicle range;
determining a charge amount needed to reach the sufficient range based on a route distance to the priority location and the current electric vehicle range; and
determining the estimated cost to charge the electric vehicle to reach the sufficient range based on the charge cost rate and the charge amount.

8. The system of claim 6, wherein the processing circuitry is further configured to:
determine whether the estimated cost exceeds a cost sensitivity index previously identified by the user; and
in response to the estimated cost exceeding the cost sensitivity index, causing a notification to be generated, which enables the user to cancel the initiation of charging at an earlier time than the charging timeframe.

9. The system of claim 8, wherein the notification comprises:
a distance the electric vehicle can travel at the sufficient range or an identification of the priority location;
the estimated cost; and
an option that enables the user to cancel the initiation of charging at an earlier time than the charging timeframe.

10. The system of claim 1, wherein the charging timeframe comprises a user-inputted charging timeframe for when to charge the electric vehicle.

11. A method, comprising:
determining, using processing circuitry, whether an electric vehicle is connected to a charger at a time outside of a charging timeframe of a charging schedule for charging the electric vehicle;
determining, using the processing circuitry, whether a current state of charge of the electric vehicle is insufficient to reach a priority location; and
in response to (a) determining that the electric vehicle is connected to a charger at a time outside of the charging timeframe of the charging schedule and (b) determining that the current state of charge of the electric vehicle is insufficient to reach the priority location, facilitating, using the processing circuitry, initiation of charging at an earlier time than the charging timeframe so that the electric vehicle is charged to a sufficient range to reach the priority location.

12. The method of claim 11, further comprising determining the priority location based on user driving history.

13. The method of claim 11, further comprising determining the priority location by searching for one or more emergency locations closest to the electric vehicle.

14. The method of claim 13, wherein the one or more emergency locations comprises one or more of a hospital, medical clinic, veterinarian office, or a user-inputted priority location.

15. The method of claim 13, wherein:
searching for the one or more emergency locations closest to the electric vehicle comprises:
determining a route distance to each of the emergency locations; and
determining a longest route distance of the determined route distances; and
determining whether the current state of charge of the electric vehicle is insufficient to reach the priority location is based on the longest route distance.

16. The method of claim 11, further comprising determining an estimated cost to charge the electric vehicle to reach the sufficient range based on a charge cost rate associated with the charging.

17. The method of claim 16, wherein determining the estimated cost to charge the electric vehicle to reach the sufficient range comprises:
identifying the charge cost rate based on a current time of day and the charger;
determining a current electric vehicle range;
determining a charge amount needed to reach the sufficient range based on a route distance to the priority location and the current electric vehicle range; and
determining the estimated cost to charge the electric vehicle to reach the sufficient range based on the charge cost rate and the charge amount.

18. The method of claim 16, further comprising:
determining whether the estimated cost exceeds a cost sensitivity index previously identified by the user; and
in response to the estimated cost exceeding the cost sensitivity index, causing a notification to be generated, which enables the user to cancel the initiation of charging at an earlier time than the charging timeframe.

19. The method of claim 18, wherein the notification comprises:
a distance the electric vehicle can travel at the sufficient range or an identification of the priority location;
the estimated cost; and
an option that enables the user to cancel the initiation of charging at an earlier time than the charging timeframe.

20. A non-transitory computer-readable medium having non-transitory computer-readable instructions encoded thereon that, when executed by processing circuitry, cause the processing circuitry to:
determine whether an electric vehicle is connected to a charger at a time outside of a charging timeframe of a charging schedule for charging the electric vehicle;
determine whether a current state of charge of the electric vehicle is insufficient to reach a priority location; and
in response to (a) determining that the electric vehicle is connected to a charger at a time outside the charging timeframe of the charging schedule and (b) determining that the current state of charge of the electric vehicle is insufficient to reach the priority location, facilitate the initiation of charging at an earlier time than the charging timeframe so that the electric vehicle is charged to a sufficient range to reach the priority location.
